(19) United States
(12) Patent Application Publication
(10) Pub. No.: US 2020/0028200 A1
(43) Pub. Date: Jan. 23, 2020

(54) METHOD FOR PRODUCING AN ELECTRODE UNIT FOR A BATTERY CELL AND ELECTRODE UNIT

(71) Applicant: Robert Bosch GmbH, Stuttgart (DE)

(72) Inventors: Daniel Sauerteig, Kernen (DE); Juergen Herold, Weismain (DE); Mathias Derra, Knetzgau (DE); Silvan Poller, Neisseaue Ot Kaltwasser (DE)

(21) Appl. No.: 16/336,327

(22) PCT Filed: Sep. 15, 2017
(86) PCT No.: PCT/EP2017/073316

§ 371 Date: Mar. 25, 2019

(30) Foreign Application Priority Data
Sep. 27, 2016 (DE) 10 2016 218 496.2

(51) Int. Cl. H01M 10/04; H01M 10/0583; H01M 2/16; H01M 10/0525

(52) U.S. Cl. CPC H01M 10/0459; H01M 10/0525; H01M 2/168; H01M 10/0583

(57) ABSTRACT

The invention relates to a method for producing an electrode unit for a battery cell comprising the following steps: substance-to-substance bonding of contact lugs (35, 36) of a plurality of plate-shaped segments of a first electrode (21, 22) to a strip-shaped first separator layer (18), substance-to-substance bonding of a strip-shaped second separator layer (19) to the contact lugs (35, 36) of the segments of the first electrode (21, 22) or to the first separator layer (18) such that a strip-shaped composite element (50) is produced, wherein an active material (41, 42) of the segments of the first electrode (21, 22) is surrounded by the first separator layer (18) and by the second separator layer (19), and arranging a plurality of plate-shaped segments of a second electrode (21, 22) on the composite element (50). The invention further relates to an electrode unit for a battery cell, produced by the method according to the invention.

### BACKGROUND OF THE INVENTION

The invention relates to a method for producing an electrode unit for a battery cell, wherein a plurality of plate-shaped segments of a first electrode are substance-to-substance bonded, in particular adhesively bonded, to a band-shaped first separator layer. The invention also relates to an electrode unit for a battery cell which is produced in accordance with the method according to the invention.

Electrical energy can be stored by means of batteries. Batteries convert chemical reaction energy into electrical energy. In this case, there is a distinction between primary batteries and secondary batteries. Primary batteries are only functional once, whilst secondary batteries, which are also known as accumulators, are rechargeable. In particular, so-called lithium-ion battery cells are used in an accumulator. These are notable, amongst other things, for high energy densities, thermal stability and an extremely low self-discharge.

Lithium-ion battery cells have a positive electrode, which is also known as a cathode, and a negative electrode, which is also known as an anode. The cathode and the anode each comprise a current collector to which an active material is applied. The electrodes of the battery cell are formed in the manner of foils and wound to form an electrode coil, with the interposition of a separator which separates the anode from the cathode. Such an electrode coil is also known as a jelly roll. The electrodes can also be layered above one another to form an electrode stack or can form an electrode unit in another manner.

The two electrodes of the electrode unit are electrically bonded to poles of the battery cell, which are also known as terminals. The electrodes and the separator are surrounded by a generally liquid electrolyte. The battery cell furthermore has a cell housing which is manufactured for example from aluminum. The cell housing is generally prismatic, in particular cuboidal, in shape and is designed to be pressure resistant. However, other housing forms, for example circular-cylindrical or flexible pouch cells are also known.

An essential aim when developing new battery cells is to increase the electrochemical useful volume in the cell. For maximizing the useful volume, the electrode stack has proven to be the most suitable design for an electrode since it can be produced both ideally prismatically and with any other geometry.

Depending on the charge state and state of ageing of the electrode unit, an expansion of the electrodes can take place which, in fully wound electrode units, can result in displacements, delaminations and heterogeneities in the region of the curves. Such ageing processes are likewise minimized in electrode stacks. As a result of a homogeneous force effect on the electrodes, which prevents a loss of contact between the electrodes and the separator, a maximum useful life of the electrode unit can be achieved.

DE 10 2006 054 308 A1 discloses an electrode arrangement in which the electrodes are fixed to the separator in the edge region by a substance-to-substance adhesive bond. In this case, the adhesive dots are located on the active material of the electrodes.

DE 10 2009 013 345 A1 likewise describes an electrode arrangement, in which the electrodes are fixed to the separator in the edge region by a substance-to-substance adhesive bond. A variant is demonstrated, in which the electrode unit is fixed in position by lateral circumferential adhesive strips. Moreover, adhesive dots are demonstrated at the corners of the electrodes and adhesive tracks are demonstrated on the longitudinal sides.

WO 2001/059870 A1 describes a construction of the electrode unit in which sub-elements comprising isolated electrodes and separators are produced. These sub-elements are then processed to form a finished electrode unit by Z-folding with a continuous separator. The separator layers are applied to the electrodes by lamination during the production of the sub-elements.

US 2013/0059183 A1 discloses a battery having an electrode unit. In this case, the electrode unit comprises a band-shaped anode and a band-shaped cathode, which are adhesively bonded to a band-shaped separator. The adhesive bonding preferably takes place in two strip-shaped regions on the current collectors of the electrodes.

US 2010/0175245 A1 discloses a method for producing an electrode stack for a battery cell. In this case, adhesive is applied to the current collector of an electrode and the electrode is thus adhesively bonded to a separator. Adhesive is likewise applied to the current collector of the other electrode, and the other electrode is adhesively bonded to a further separator.

US 2010/0196167 A1 reveals an electrode unit for a battery cell and a method for producing the electrode unit. In this case, the cathode is adhesively bonded to a first separator and the anode is adhesively bonded to a second separator.

EP 2 958 179 A1 also discloses an electrode unit for battery cells and a method for producing the electrode unit. In this case, band-shaped electrodes are cut into plate-shaped segments and arranged on band-shaped separators. The two separators with the electrode segments are then adhesively bonded to one another. The mutually adhesively bonded separators with the electrode segments are then cut and stacked.

### SUMMARY OF THE INVENTION

A method for producing an electrode unit for a battery cell is proposed. In this case, the method comprises at least the steps described below.

In a first step, contact tabs of a plurality of plate-shaped segments of a first electrode are substance-to-substance bonded to a band-shaped first separator layer. In this case, the first electrode can be an anode or equally a cathode. Possible substance-to-substance bonding procedures are in particular adhesive bonding but also fusing, for example.

The first separator is flat and band-shaped in form. In this connection, this means that an extent of the first separator layer in a longitudinal direction is much greater, in particular at least ten times greater, than an extent of the first separator layer in a transverse direction which is orientated at a right angle to the longitudinal direction.

The segments of the first electrode are flat and plate-shaped in form. In this connection, this means that an extent of a segment of the first electrode in the longitudinal direction is approximately the same size, in particular at least half the size and at most twice the size, in relation to an extent of the segment of the first electrode in the transverse direction.

The segments of the first electrode each comprise a current collector, which is formed as a metal foil and to which an active material is applied, preferably on both sides. In this case, a contact tab projects away from the current collector, which contact tab is not coated with the active material, i.e. it is free from the active material. The contact tabs of the segments of the first electrode serve for establishing contact between the segments of the first electrode and with a terminal of the battery cell.

In particular, the contact tabs of the segments of the first electrode are exclusively substance-to-substance bonded to the first separator layer. Direct bonding of the active material of the segments of the first electrode to the first separator layer is therefore not provided.

In a second step, a band-shaped second separator layer is substance-to-substance bonded to the contact tabs of the segments of the first electrode, or a band-shaped second separator layer is substance-to-substance bonded to the first separator layer. Direct bonding of the active material of the segments of the first electrode to the second separator layer is likewise not provided.

In this case, a band-shaped composite element is produced, which comprises the first separator layer, the second separator layer and the segments of the first electrode. In this case, the segments of the first electrode are arranged substantially between the two separator layers. In this case, the active material of the segments of the first electrode are surrounded by the first separator layer and by the second separator layer. The contact tabs of the segments of the first electrode project out between the two separator layers and are contactable from the outside.

In a third step, a plurality of plate-shaped segments of a second electrode are arranged on the composite element. If the first electrode is the anode, the second electrode is the cathode. If the first electrode is the cathode, the second electrode is the anode.

In this case, the segments of the second electrode are arranged on a side of the first separator layer or the second separator layer which is remote from the segments of the first electrode. One of the two separator layers is therefore always located between a segment of the first electrode and a segment of the second electrode.

The first separator layer and the second separator layer can be formed separately from one another as separate foils, for example. However, the first separator layer and the second separator layer can also be formed as a single-piece foil. In this case, after the first step, the second separator layer is bent through 180° along the longitudinal axis, relative to the first separator layer, and, in the second step, placed on the segments of the first electrode.

According to an advantageous embodiment of the invention, during the third step, the composite element is folded in alternate directions between the segments of the first electrode. This operation is also known as “Z-folding”. In the third step, the segments of the second electrode are then arranged alternately on the first separator layer and on the second separator layer of the composite element. The segments of the second electrode therefore abut against the first separator layer or against the second separator layer on both sides in each case.

According to another advantageous embodiment of the invention, during the third step, the composite element is folded in the same direction between the segments of the first electrode. This operation is similar to winding, although the segments of the first element remain flat and do not assume a curvature. In the third step, the segments of the second electrode are then arranged on the first separator layer and covered by the second separator layer, or the segments of the second electrode are arranged on the second separator layer and covered by the first separator layer. The segments of the second electrode are therefore each located between the first separator layer and the second separator layer.

According to a further advantageous embodiment of the invention, during the third step, the composite element is separated between the segments of the first electrode. This operation is also known as “isolation”. As a result of the isolation, isolated composite segments are produced, which each have a segment of the first electrode. In the third step, the composite segments and the segments of the second electrode are then stacked alternately. The segments of the second electrode are therefore each located between the first separator layer and the second separator layer.

According to an advantageous variant embodiment, prior to the first step, a strip-shaped first adhesive film is applied to the first separator layer, in particular in an edge region. The contact tabs of the segments of the first electrode are then adhesively bonded to the first separator layer by means of the first adhesive film in the first step. In the second step, the second separator layer is then adhesively bonded to the first separator layer by means of the first adhesive film.

According to an alternative advantageous variant embodiment, prior to the first step, a respective strip-shaped third adhesive film is applied to the contact tabs of the segments of the first electrode, in particular in an edge region, on both sides. The contact tabs of the segments of the first electrode are then adhesively bonded to the first separator layer by means of the third adhesive film in the first step. In the second step, the second separator layer is adhesively bonded to the contact tabs of the segments of the first electrode by means of the third adhesive film.

The contact tabs of the segments of the second electrode are preferably substance-to-substance bonded, preferably adhesively bonded, to the composite element, in particular to a separator layer.

To this end, for example prior to the third step, a strip-shaped second adhesive film is applied to the second separator layer, in particular in an edge region. In the third step, the contact tabs of the segments of the second electrode are then adhesively bonded to the second separator layer by means of the second adhesive film.

Alternatively, prior to the third step, a strip-shaped fourth adhesive film is applied to the contact tabs of the segments of the second electrode, in particular in an edge region. In the third step, the contact tabs of the segments of the second electrode are then adhesively bonded to the second separator layer by means of the fourth adhesive film.

An electrode unit for a battery cell is also proposed, which is produced in accordance with the method according to the invention.

An electrode unit according to the invention is advantageously used in a battery cell in an electric vehicle (EV), in a hybrid vehicle (HEV), in a plug-in hybrid vehicle (PHEV) or in a consumer electronic product. Consumer electronic products refer in particular to mobile telephones, tablet PCs or notebooks.

The method according to the invention enables precise positioning of the segments of the electrodes relative to the separator layers. It is thus particularly possible to realize a continuous production process with a relatively high process speed and low manufacturing tolerances. The method according to the invention enables the production of the electrode unit by means of Z-folding, winding or stacking procedures, amongst others. The method according to the invention can be applied to various types of separator layers, including ceramic coated separators and fiber separators.

In this case, the active materials of the electrodes are advantageously free from adhesive, whilst the adhesive of the adhesive films does not have a negative influence on the electromechanical behavior of the electrode unit. In particular, the adhesive does not cause an increase in the internal resistance of the electrode unit. The performance and aging behavior of the electrode unit are therefore advantageously improved.

The adhesive films further protect the electrode unit against the penetration of foreign particles, for example chips. The adhesive additionally contributes to fixing the separator layers mechanically in place and prevents shrinkage of the separator layers, in particular under an excessive thermal load. The reliability of the electrode unit and the battery cell is thus further increased.

### BRIEF DESCRIPTION OF THE DRAWINGS

Embodiments of the invention are explained in more detail with reference to the drawings and the description below.

The drawings show:

FIG. 1 a schematic illustration of a battery cell,

FIGS. 2a-c steps for producing an electrode unit according to a first variant embodiment,

FIGS. 3a-c steps for producing an electrode unit according to a second variant embodiment,

FIG. 4 a schematic sectional illustration of an electrode unit produced by Z-folding,

FIG. 5 a schematic sectional illustration of an electrode unit produced by winding, and

FIG. 6 a schematic sectional illustration of an electrode unit produced by stacking.

### DETAILED DESCRIPTION

In the following description of the embodiments of the invention, identical or similar elements are denoted by the same reference signs, whereby repeated description of these elements is omitted in individual cases. The figures represent the subject matter of the invention merely schematically.

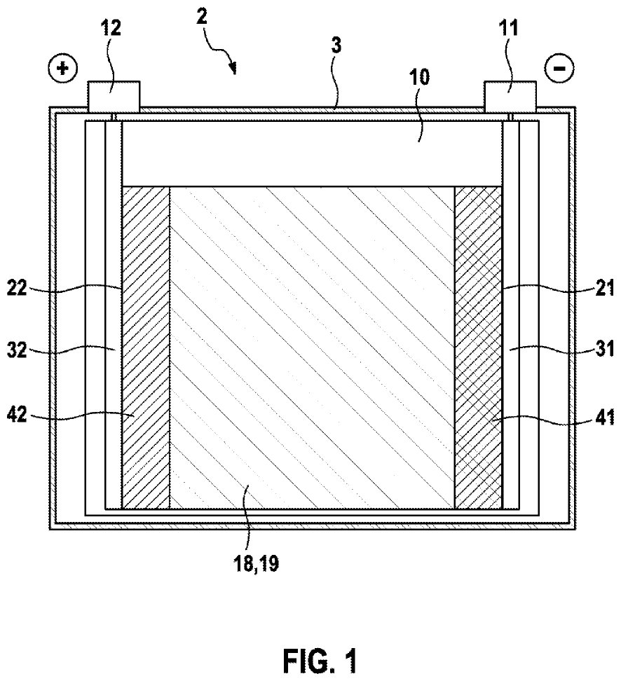

FIG. 1 shows a schematic illustration of the battery cell 2. The battery cell 2 comprises a housing 3, which is prismatic, in the present case cuboidal, in form. In the present case, the housing 3 is designed to be electrically conductive and is manufactured from aluminum, for example.

The battery cell 2 comprises a negative terminal 11 and a positive terminal 12. A voltage provided by the battery cell 2 can be picked off via the terminals 11, 12. Furthermore, the battery cell 2 can also be charged via the terminals 11, 12.

An electrode unit 10, which is constructed as an electrode stack in the present case, is arranged within the housing 3 of the battery cell 2. The electrode unit 10 has two electrodes, namely an anode 21 and a cathode 22. The anode 21 and the cathode 22 are each constructed in the manner of a foil and are separated from one another by at least one separator layer 18, 19. The at least one separator layer 18, 19 is ionically conductive, i.e. permeable to lithium ions.

The anode 21 comprises an anode active material 41 and a current collector 31. The current collector 31 of the anode 21 is constructed to be electrically conductive and is manufactured from a metal, for example from copper. The current collector 31 of the anode 21 is electrically bonded to the negative terminal 11 of the battery cell 2.

The cathode 22 comprises a cathode active material 42 and a current collector 32. The current collector 32 of the cathode 22 is constructed to be electrically conductive and is manufactured from a metal, for example from aluminum. The current collector 32 of the cathode 22 is electrically bonded to the positive terminal 12 of the battery cell 2.

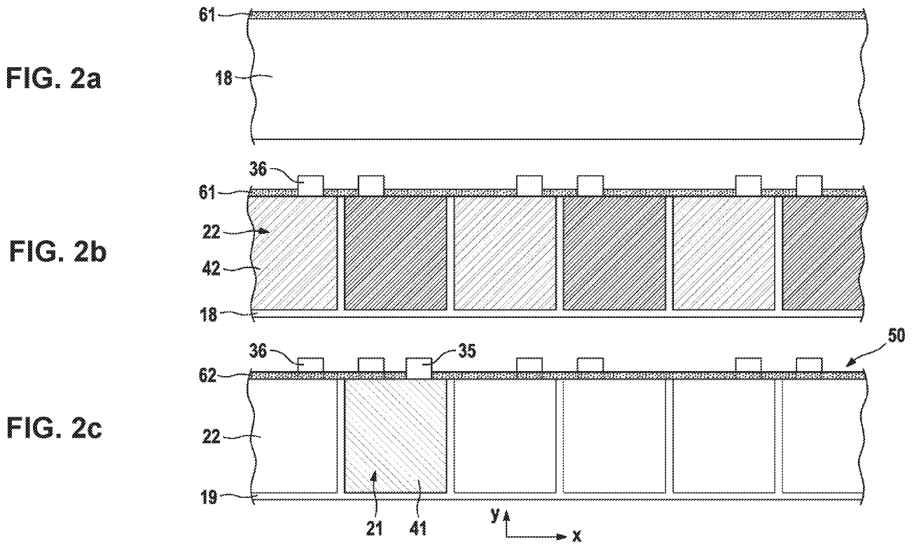

Steps for producing an electrode unit 10 according to a first variant embodiment are illustrated in FIG. 2. As shown in FIG. 2a, a first adhesive film 61 is applied to an edge region of a first separator layer 18 formed in a band shape. It should be understood hereinafter that, in the case of a band-shaped form, an extent in a longitudinal direction x is much greater than an extent in a transverse direction y, which is orientated at a right angle to the longitudinal direction x.

In this case, the first adhesive film 61 can be applied as an adhesive strip, as an adhesive band or as a spray adhesive via a transfer method, for example.

In addition to pressure sensitive adhesives, it is also possible to use adhesives which can be activated in different manners. In a further alternative embodiment, the first separator layer 18 can also be thermally fused and therefore likewise generate a substance-to-substance bond.

In FIG. 2b, it is shown how a plurality of segments of a cathode 22, which are formed in a plate shape, are positioned as a first electrode on the first separator layer 18. It should be understood hereinafter that, in the case of a plate-shaped form, an extent in the longitudinal direction x is approximately the same size as an extent in the transverse direction y.

The segments of the cathode 22 each have a current collector 32, which is coated with the cathode active material 42. A contact tab 36 of the cathode 22 projects away from the current collector 32, which contact tab is not coated and is therefore free from cathode active material 42. The segments of the cathode 22 are positioned on the first separator layer 18 in such a way that the contact tabs 36 of the cathode 22 adhere to the first adhesive film 61, whereby the segments of the cathode 22 are adhesively bonded to the first separator layer 18.

In this case, the orientation and position of the individual segments of the cathode 22 are matched to the further production process of the electrode unit 10 so that the contact tabs 36 of the cathode 22 are located above one another after a subsequent winding, folding or stacking procedure. In the present illustration, the position and orientation are adapted for Z-folding.

Finally, as illustrated in FIG. 2c, a band-shaped second separator layer 19 is placed congruently over the first separator layer 18 and adhesively bonded to the first separator layer 18 by means of the first adhesive film 61. This produces a band-shaped composite element 50, which is illustrated partly transparently. In this case, the active material 42 of the cathode 22 is surrounded by the first separator layer 18 and by the second separator layer 19 and only the contact tabs 36 of the cathode 22 project out between the separator layers 18, 19.

In the present case, a second adhesive film 62 is applied to an edge region of the second separator layer 19. A plurality of segments of an anode 21 which are formed in a plate shape are then positioned as a second electrode on the second separator layer 19 of the composite element 50, with only one segment of the anode 21 being illustrated.

The segments of the anode 21 each have a current collector 31, which is coated with the anode active material 41. A contact tab 35 of the anode 21 projects away from the current collector 31, which contact tab is not coated, i.e. it is free from anode active material 41. The segments of the anode 21 are positioned on the second separator layer 19 in such a way that the contact tabs 35 of the anode 21 adhere to the second adhesive film 62, whereby the segments of the anode 21 are adhesively bonded to the second separator layer 19.

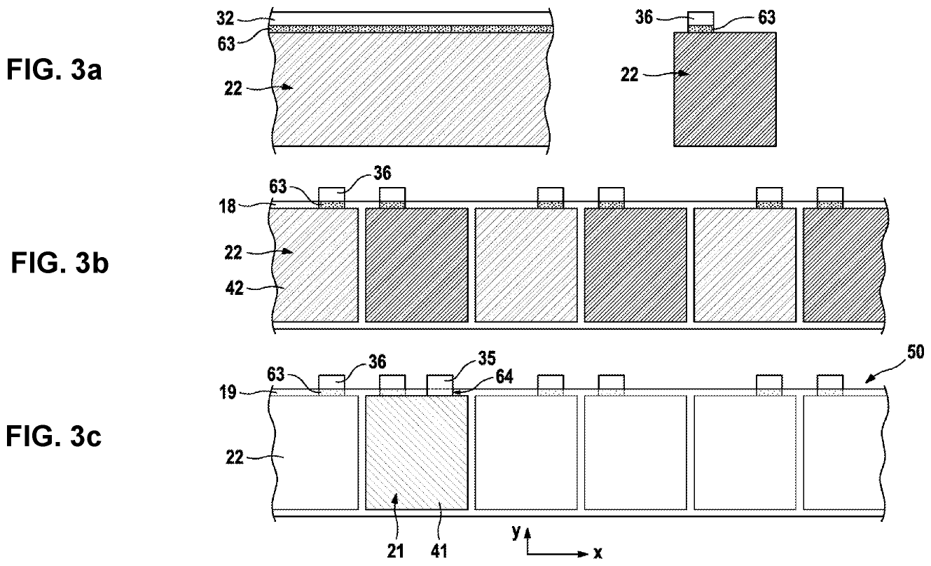

Steps for producing an electrode unit 10 according to a second variant embodiment are illustrated in FIG. 3. As shown in FIG. 3c, a third adhesive film 63 is applied to an edge of the uncoated current collector 32 of a band-shaped cathode 22 on both sides. In this case, the third adhesive film 63 can be applied as an adhesive strip, as an adhesive band or as a spray adhesive via a transfer method, for example. Segments of the cathode 22 which are formed in a plate shape are produced from the band-shaped cathode 22 by isolation. In this case, the contact tabs 36 of the segments of the cathode 22 are provided with the third adhesive film 63.

The segments of the cathode 22 are applied as a first electrode to the band-shaped first separator layer 18, as illustrated in FIG. 3b. In this case, the contact tabs 36 of the segments of the cathode 22 are adhesively bonded to the first separator layer 18 by means of the third adhesive film 63.

In this case, the orientation and position of the individual segments of the cathode 22 are matched to the further production process of the electrode unit 10 so that the contact tabs 36 of the cathode 22 are located above one another after the subsequent winding, folding or stacking procedure. In the present illustration, the position and orientation are adapted for Z-folding.

Finally, as illustrated in FIG. 3c, the band-shaped second separator layer 19 is placed congruently over the first separator layer 18 and adhesively bonded to the contact tabs 36 of the segments of the first cathode 22 by means of the third adhesive film 63. This produces a band-shaped composite element 50, which is illustrated partly transparently. In this case, the active material 42 of the cathode 22 is surrounded by the first separator layer 18 and by the second separator layer 19 and only the contact tabs 36 of the cathode 22 project out between the separator layers 18, 19.

A plurality of segments of the anode 21 which are formed in a plate shape are then positioned as a second electrode on the second separator layer 19 of the composite element 50, with only one segment of the anode 21 being illustrated. Prior to this, a fourth adhesive film 64 is applied to an edge region of the contact tabs 35 of the segments of the anode 21. The segments of the anode are positioned on the second separator layer 19 in such a way that the contact tabs 35 of the anode 21 are adhesively bonded to the second separator layer 19 by means of the fourth adhesive film 64.

In the first variant embodiment and in the second variant embodiment, the first adhesive film 61, the second adhesive film 62, the third adhesive film 63 and the fourth adhesive film 64 can be constructed as polyolefin-based hot-melt adhesives or as acrylate-based adhesives, for example. Moreover, the adhesives can contain ceramic fillers, for example A1203.

The first adhesive film 61, the second adhesive film 62, the third adhesive film 63 and the fourth adhesive film 64 are preferably applied in a width of 2 mm or less. In this case, the width of the adhesive films 61, 62, 63, 64 corresponds to their extent in the transverse direction y.

Instead of strip-shaped adhesive films 61, 62, 63, 64 it is also conceivable to use adhesive dots. Such adhesive dots preferably have a maximum diameter of 2 mm and are preferably at a maximum spacing of 20 mm from one another. The application of such adhesive dots can take place for example by means of a method known as “jetting”.

The second adhesive film 62 in the first variant embodiment and the fourth adhesive film 64 in the second variant embodiment can also be omitted and the segments of the anode 21 as a second electrode, which are formed in plate shape, can be simply positioned on the second separator layer 19 of the composite element 50.

In the first variant embodiment, as in the second variant embodiment, the segments of the anode 21 as a second electrode can be positioned in such a way that the contact tabs 35 of the anode 21 point in the same direction as the contact tabs 36 of the cathode 22. The segments of the anode 21 as a second electrode can likewise be positioned in such a way that the contact tabs 35 of the anode 21 point in the opposite direction to the contact tabs 36 of the cathode 22.

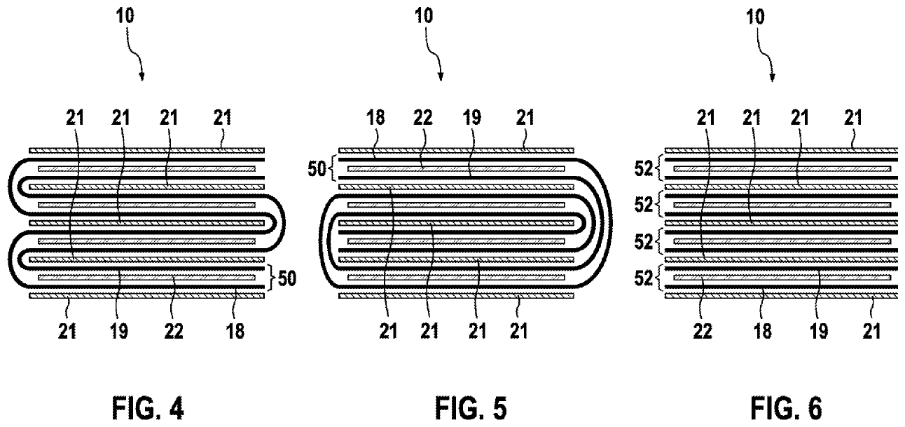

FIG. 4 shows a schematic sectional illustration of an electrode unit 10 produced by Z-folding. In this case, the composite element 50 is folded in alternate directions between the segments of the cathode 22. The segments of the anode 21 are arranged alternately on the first separator layer 18 and on the second separator layer 19.

FIG. 5 shows a schematic sectional illustration of an electrode unit 10 produced by winding. In this case, the composite element 50 is always folded in the same direction between the segments of the cathode 22. The segments of the anode 21 are arranged on one of the two separator layers 18, 19 and covered by the other of the two separator layers 18, 19 during the winding procedure. The segments of the anode 21 are subsequently each located between the first separator layer 18 and the second separator layer 19 of the composite element 50. Only the centrally placed segment of the anode 21 is exclusively surrounded by the second separator layer 19.

FIG. 6 shows a schematic sectional illustration of an electrode unit 10 produced by stacking. In this case, the composite element 50 is separated between the segments of the cathode 22. As a result of this isolation, composite segments 52 are produced, which each have a segment of the cathode 22. The composite segments 52 and the segments of the anode 21 are then stacked alternately. The segments of the anode 21 are subsequently each located between the first separator layer 18 and the second separator layer 19 of the composite segments 52.

The invention is not restricted to the exemplary embodiments described here and the aspects highlighted therein. Instead, within the field described by the claims, a plurality of modifications is possible which are within the scope of professional practice.

1. A method for producing an electrode unit (10) for a battery cell (2), comprising the following steps:
substance-to-substance bonding of contact tabs (35, 36) of a plurality of plate-shaped segments of a first electrode (21, 22) to a band-shaped first separator layer (18),
substance-to-substance bonding of a band-shaped second separator layer (19) to the contact tabs (35, 36) of the segments of the first electrode (21, 22) or to the first separator layer (18) so that a band-shaped composite element (50) is produced, wherein an active material (41, 42) of the segments of the first electrode (21, 22) is surrounded by the first separator layer (18) and by the second separator layer (19), and
arranging a plurality of plate-shaped segments of a second electrode (21, 22) on the composite element (50).

2. The method as claimed in claim 1, wherein
the composite element (50) is folded in alternate directions between the segments of the first electrode (21, 22) and wherein the segments of the second electrode (21, 22) are arranged alternately on the first separator layer (18) and on the second separator layer (19).

3. The method as claimed in claim 1, wherein
the composite element (50) is folded in the same direction between the segments of the first electrode (21, 22) and wherein the segments of the second electrode (21, 22) are arranged on the first separator layer (18) or on the second separator layer (19).

4. The method as claimed in claim 1, wherein
the composite element (50) is separated between the segments of the first electrode (21, 22) so that composite segments (52) are produced, and wherein
the composite segments (52) and the segments of the second electrode (21, 22) are stacked alternately.

5. The method as claimed in claim lone of the preceding claims, wherein a strip-shaped first adhesive film (61) is applied to the first separator layer (18),
the contact tabs (35, 36) of the segments of the first electrode (21, 22) are adhesively bonded to the first separator layer (18) by means of the first adhesive film (61), and
the second separator layer (19) is adhesively bonded to the first separator layer (18) by means of the first adhesive film (61).

6. The method as claimed in claim 1, wherein
a respective strip-shaped third adhesive film (63) is applied to the contact tabs (35, 36) of the segments of the first electrode (21, 22) on both sides,
the contact tabs (35, 36) of the segments of the first electrode (21, 22) are adhesively bonded to the first separator layer (18) by means of the third adhesive film (63), and
the second separator layer (19) is adhesively bonded to the contact tabs (35, 36) of the segments of the first electrode (21, 22) by means of the third adhesive film (63).

7. The method as claimed in claim 1, characterized in that
the contact tabs (35, 36) of the segments of the second electrode (21, 22) are substance-to-substance bonded to the composite element (50).

8. The method as claimed in claim 7, wherein
a strip-shaped second adhesive film (62) is applied to the second separator layer (19) and wherein the contact tabs (35, 36) of the segments of the second electrode (21, 22) are adhesively bonded to the second separator layer (19) by means of the second adhesive film (62).

9. The method as claimed in claim 7, wherein
a strip-shaped fourth adhesive film (64) is applied to the contact tabs (35, 36) of the segments of the second electrode (21, 22), and wherein
the contact tabs (35, 36) of the segments of the second electrode (21, 22) are adhesively bonded to the second separator layer (19) by means of the fourth adhesive film (64).

10. (canceled)

11. A method for producing an electric vehicle (EV), a hybrid vehicle (REV), a plug-in hybrid vehicle (PHEV) or a consumer electronic product, the method comprising producing an electrode unit (10) for a battery cell (2), the electrode unit being produced by:
substance-to-substance bonding of contact tabs (35, 36) of a plurality of plate-shaped segments of a first electrode (21, 22) to a band-shaped first separator layer (18),
substance-to-substance bonding of a band-shaped second separator layer (19) to the contact tabs (35, 36) of the segments of the first electrode (21, 22) or to the first separator layer (18) so that a band-shaped composite element (50) is produced, wherein an active material (41, 42) of the segments of the first electrode (21, 22) is surrounded by the first separator layer (18) and by the second separator layer (19), and
arranging a plurality of plate-shaped segments of a second electrode (21, 22) on the composite element (50).

12. The method as claimed in claim 1, characterized in that
the contact tabs (35, 36) of the segments of the second electrode (21, 22) are adhesively bonded to the composite element (50).
